(19) United States
(12) Patent Application Publication
(10) Pub. No.: US 2007/0007889 A1
(43) Pub. Date: Jan. 11, 2007

(54) Dynamic foil display having low resistivity electrodes

(75) Inventors: Petrus Franciscus Gerardus Bongaerts, Eindhoven (NL); Matheus Godefridus Johannus Bel, Eindhoven (NL); Peter Alexander Duine, Eindhoven (NL); Johannes Gijsbertus Antonius Den Biggelaar, Eindhoven (NL); Johannes Marra, Eindhoven (NL); Tijsbert Mathieu Henricus Creemers, Gerstweg (NL); Roland Marinus Schuurbiers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/557,344

(22) PCT Filed: May 14, 2004
(86) PCT No.: PCT/IB04/50699

§ 371 Date: Nov. 21, 2005

(30) Foreign Application Priority Data
May 22, 2003 (EP) 03101483.0

(51) Int. Cl. H01J 1/62; H01J 63/04

(52) U.S. Cl. 313/506

(57) ABSTRACT

A dynamic foil display 900 is provided wherein the spacer elements 902, 904 also serve as resistance-reducing tracks for the electrode circuitry. Resistance-reduction can thereby be provided for the row and column electrodes as well as for the foil electrode. To this end a foil display 900 comprises a light guide plate 905; a passive plate 910; and a transparent light-scattering foil 903 sandwiched between and separated from said plates by means of spacer elements 902, 904 is described. The spacer elements 902, 904 are arranged essentially along rows and columns on said plates 905, 910 and thereby define a plurality of pixel elements arranged in a matrix configuration along said rows and columns. The display further comprises an electrode circuitry which comprises a transparent foil electrode 907 arranged laterally on said foil and transparent row and column electrodes 901, 911 arranged along said rows and columns on said light guide and passive plates; and the spacer elements 902, 904 are electrically conducting and interconnected with said electrodes 907, 911, 901 and thus form part of said electrode circuitry.

A Dynamic Foil Display (DFD) typically comprises a display panel having an active light guide plate, a passive plate, and a movable, light-scattering foil sandwiched between these plates. The foil is arranged with a transparent common foil electrode substantially covering the surface area of at least one side of the foil. Pixels are typically arranged in a matrix configuration, each pixel being located at the intersection of a horizontal, transparent row electrode arranged on the passive plate and a vertical, transparent column electrode arranged on the active plate. Each pixel is separated from its neighbors by means of spacers, deposited between and spatially separating the foil from the active and passive plates. The spacers are typically 1 micrometer in height, and, at least on the light guide plate, are formed out of a specular-reflective material possessing a high reflectivity towards light in the visible wavelength region.

Depending on the voltage setup between the row, column, and foil electrodes, electrostatic forces can be created locally forcing the foil into contact with either the active light guide plate or the passive plate, resulting in the pixel being either activated (light-emitting) or inactivated (dark), respectively. In order to avoid cross talk between neighboring pixels due to unintended foil deformations, the spacers are typically arranged along rows and columns so as to surround each pixel. In a sense, each pixel thus constitutes a separate pixel cell. To avoid electrical short-circuiting between the foil electrode and the plate electrodes, the spacers are arranged on the display plates at locations in between adjacent plate electrodes and are thus kept insulated from them.

The light guide is coupled to a light source, which typically is edge-mounted on the light guide. In case a pixel is activated, the movable foil is locally brought into contact with the light guide plate and light is decoupled out of the light guide plate into the foil where it is scattered out of the display, resulting in a bright, light-emitting pixel. The pixel remains in this active state until it is deactivated (darkened), i.e. until the foil-light guide contact is interrupted, and vice versa.

Arranging a suitable color filter onto the passive plate portion of each pixel provides for color pixels or sub-pixels. In order to provide for RGB displays, the pixels are typically arranged in sub-pixel groups, each sub-pixel group constituting a RGB pixel and consisting of a red, a green and a blue sub-pixel.

According to current designs, the row and column electrodes and the foil electrode are all constituted by transparent ITO (Indium Tin Oxide) layers having limited thickness in order to minimize light losses and/or color shifts due to incurred light absorption in the ITO electrodes. The ITO thickness is typically as small as 30 nm. However, having such thin electrodes results in a limited electrical conductivity. In fact, the RC-time (Resistance-Capacitance time, the time needed for addressing) of the row and column electrodes in the foil display environment, which is characterized by a relatively high pixel capacitance C, is so long that voltage pulses imposed on these electrodes by voltage drivers during display operation cannot be sent with a sufficiently high speed across the entire length of the electrodes.

To reduce the electrode RC-time, a metallic resistance-reducing track is deposited on top of parts of the ITO row and column electrodes. These resistance-reducing tracks typically consist of a 100-200 nm thick and 20-25 micrometers wide aluminum strip located on and along one or both edges of the respective ITO electrodes. The advantage of this design is that the RC time of the ITO electrodes is reduced (indeed due to the presence of the resistance-reducing metallic tracks) while the risk for spacer-induced electrical short-circuit formation between the foil electrode and the row/column electrodes is kept minimal since the spacers are still electrically insulated from the row and column electrodes and also from the metallic resistance-reducing tracks disposed on the row and column electrodes.

Electrical short-circuit formation between the column electrodes and the foil electrode and between the row electrodes and the foil electrode is typically prevented by means of an insulating layer covering the row and column electrodes.

However, drawbacks of the current designs include:

The width of the metallic resistance-reducing tracks on the ITO row- and column electrodes cannot be made too large, otherwise a significant pixel aperture reduction occurs, while the height of the resistance-reducing tracks must be kept below about 200-300 nm, otherwise their protruding presence interferes with the switching behavior of the foil between the active plate and the passive plate and vice-versa. These constraints result in an insufficient decrease of the RC-time even when the ITO row and column electrodes are provided with resistance-reducing tracks, in particular when large-area displays are concerned.

It has been experienced that when resistance-reducing aluminum tracks of finite width and height are deposited directly on top of ITO (for the purpose of making ohmic contact with the ITO), a chemical (probably electro-chemical) reaction occurs between the aluminum and the ITO leading to a darkening of the aluminum/ITO interface. On the light guide plate in particular, this induces unwanted light absorption and thus a loss of light and possibly also a color shift. Furthermore, the adhesion between aluminum and ITO appears to be weaker than the adhesion between glass (SiO₂) and Al, resulting in a ready delamination of the aluminum resistance-reducing tracks from the ITO electrodes during processing. Aluminum can indeed be replaced by silver, but silver has the drawback of a poor chemical stability over time leading to a darkening effect and thus also unwanted loss of light. Replacing aluminum or silver with another metal (such as chromium or titanium), leads to a significantly increased absorption of light and is therefore not a good solution.

A large number of process steps are required to manufacture/structure the ITO electrodes, the resistance-reducing tracks, and the spacer patterns on the panel plates.

The resistance-reducing tracks do not improve the conductivity of the foil electrode, which of course also affects the RC-time and thus the addressing performance of the display.

An object of the present invention is thus to provide improved foil displays, in which the implications of the above drawbacks are alleviated. This object is achieved in the foil display as defined in the appended independent claim, and the appended sub-claims provide preferred embodiments of the invention.

Whatever the layout, a common characteristic of prior art designs is that the spacers are not part of the row/column/foil electrode circuitry. For the purpose of the present invention, it has been realized that a spacer element and a resistance-reducing track advantageously can be incorporated into one single element.

Thus, according to one aspect of the invention a foil display is provided comprising: a light guide plate; a passive plate; and a transparent light-scattering foil sandwiched between and separated from said plates by means of spacer elements. The spacer elements are arranged essentially along rows and columns on said plates and thereby define a plurality of pixel elements arranged in a matrix configuration along said rows and columns. The inventive display further comprises an electrode circuitry comprising a transparent foil electrode arranged laterally on said foil and transparent row and column electrodes arranged along said rows and columns on said light guide and passive plates. The spacer elements are electrically conducting and interconnected with said electrodes and thus form part of said electrode circuitry.

From one point of view, the invention is thus based on the insight that the resistance-reducing tracks can be moved to a large degree aside from the ITO electrode layers and instead be mainly deposited directly on the glass plate, in parallel with the ITO electrode layers. Sufficient electrical contact between a resistance-reducing track and the associated ITO layer can be provided by means of limited-area electrical contact points distributed along the ITO electrode layer. This is advantageous in that the risk for delamination of the resistance-reducing track from the ITO electrodes is reduced, since the adhesion of aluminum on glass is much better than it is on ITO. Thereby, also, the light absorbing areas (which become darkened due to said chemical reactions between the aluminum and the ITO) are substantially restricted in size to the areas of the contact points only, instead of being spread all along the entire plate areas occupied by the resistance-reducing tracks.

From another point of view, the invention is based on the insight that spacer elements can form part of the electrode circuitry, and thus eliminate the need for additional resistance-reducing tracks on the transparent electrodes.

According to one embodiment, some of the spacer elements are essentially parallel with said row electrodes and electrically interconnected therewith. For example, in cases where row directed electrodes are arranged on the passive plate these can be electrically incorporated with the respective electrodes and thus be made to substitute the resistance-reducing tracks associated with the ITO row electrodes. This can be achieved by forming the row-directed spacers at least partly from a conductive material, by establishing electrical contact between the row-directed spacers and their associated ITO row electrodes by means of limited-area contact points distributed along the ITO row electrode layers, and by proper electrical insulation of the conductive part of the row-directed spacers from the foil electrode.

According to one embodiment, some of the spacer elements are essentially parallel with said column electrodes and electrically interconnected therewith. For example, in cases where column directed electrodes are arranged on the light guide plate these can be electrically incorporated with the respective electrodes and thus be made to substitute the resistance-reducing tracks associated with the ITO column electrodes. This can be achieved by forming the spacers at least partly from a conductive material, by establishing electrical contact between the spacers and their associated ITO electrodes by means of limited-area contact points distributed along the ITO column electrode layers, and by proper electrical insulation of the conductive part of the spacers from the foil electrode. When the foil electrode is arranged on the foil side facing the passive plate, electrical insulation between the foil electrode and the column electrodes including the spacers is at least partly provided for by the foil material itself, since this typically is made out of an insulating material.

Obviously, the row electrodes can instead be arranged on the light guide plate and the column electrodes are thus arranged on the passive plate. In such cases, the above embodiments are readily applicable simply by applying the description for the passive plate to the light guide plate and vice versa.

For both the column electrodes and the row electrodes, proper electrical insulation from the foil electrode can be provided for by means of an insulating layer deposited onto the ITO part of the plate electrodes and on the electrically conducting part of the spacer elements associated with the plate electrodes, thus effectively insulating the spacers associated with the plate electrodes and the ITO of the plate electrodes from the foil electrode.

According to one embodiment, some of the spacer elements on at least one of said plates are electrically interconnected with said foil electrode and are spatially separated from and extends in a direction essentially transversal to the remaining spacer elements on said at least one plate. For example, in case the foil electrode is arranged on the passive plate side of the foil and the row directed electrodes are arranged on the passive plate, column-directed spacer elements on the passive plate can be electrically incorporated with the foil electrode and thus be made to serve as resistance-reducing tracks for the foil electrode. This is advantageous in that the resistance of the foil electrode is substantially reduced. It can be achieved by forming the column-directed spacer elements on the passive plate at least partly from a conductive material on the side of column-directed spacer elements facing the foil, by arranging the foil electrode at least on the foil side facing the passive plate, by establishing electrical contact between the foil electrode and the column-directed spacer elements, and by electrically insulating the column-directed spacer elements from the row electrodes and the row-directed spacer elements that are electrically incorporated with the row electrodes. Proper electrical contact between the foil electrode on the foil side facing the passive plate and the column directed spacer elements is naturally provided for as a result of the sandwiching of the foil between the spacer elements arranged on the light guide plate and the passive plate, respectively. In case the foil electrode is arranged on the light guide side of the foil, some of the spacer elements on the light guide are instead in similar fashion interconnected with the foil electrode.

According to one embodiment, the transparent electrodes are formed out of ITO and the spacer elements optionally comprise aluminum.

According to another embodiment, the spacer elements which are electrically interconnected with the row or column electrodes are deposited partially on the respective transparent electrodes and partially on the respective plate. Thus, the light absorbing areas can be restricted in size while sufficient electrical contact is still provided for between the spacer elements and the associated ITO electrodes on the active and passive plates, respectively. Preferably, the contact between the ITO electrodes and the spacer elements are provided at regularly spaced contact points.

According to one embodiment, at least some of the spacer elements comprise: a highly-reflective specular-reflecting adhesion layer of Al or Ag, a first protecting layer of a high-melting metal like Cr deposited on said adhesion layer; a conducting metal layer (e.g. Al) deposited on said protecting layer; and a second protecting layer of an alkaline-resistant metal like Cr, deposited on said conducting metal layer. Preferably, the Al or Ag adhesion layer associated with the spacer elements on the light guide plate and the row-directed spacer elements on the passive plate are partly deposited on the ITO layers associated with the column and row electrodes, respectively, to form local electrical contact points, and are partly deposited aside from the ITO layers directly on the glass substrate plates. The Al or Ag adhesion layer associated with spacer elements that are to form part of the foil electrode circuitry is deposited entirely and directly on the glass of the substrate plates. The presence of highly reflective Al or Ag in the adhesion layer allows only a minimized amount of light absorption to occur with respect to light propagating through the light guide plate. The presence of a high-melting metal like Cr in the protecting layer prevents the occurrence of spacer element deformations that may otherwise occur due to a thermal expansion mismatch between the substrate material (glass) and the metal layer adhering to the substrate when the spacer elements are subjected to high processing temperatures, for example during CVD deposition (Chemical Vapor Deposition) or sputter deposition of an inorganic insulating layer on the spacer elements. Spacer element deformations may express themselves as pronounced local metallic protrusions (hillocks) from the top surfaces of the spacer elements facing the foil. Hillocks, denoting large spikes of aluminum that can form when the aluminum is subjected to processing temperatures above 250° C., are due to differences in the thermal coefficients of aluminum and the substrate glass. Such processing temperatures occur for example during the deposition of an insulating SiO₂ layer by a CVD deposition process on top of the electrodes. Hillock spikes can create unwanted electrical short-circuits.

The conducting metal layer deposited on said protecting layer serves to lower the overall electrical resistance of the spacer elements and may comprise any metallic low-resistance material. Said second protecting layer of an alkaline-resistant metal like Cr, deposited on said conducting metal layer, serves to protect the spacer elements against chemical attack from the alkaline photoresist-stripping liquids that are normally used for stripping of photo-resist material from the spacer elements after having completed photolithographic structuring of the spacer elements on the plates.

Such a composite spacer element thus provides for excellent electrical conductivity, improved adhesion to the substrate as compared to homogeneous aluminum spacer elements, and reduced chance of hillocks-induced short-circuit formation between the foil electrode and the row and column electrodes. By disposing the spacer elements only partly on the ITO of their associated column and row electrodes, respectively, it is possible to limit the overall darkened interface area between the spacer elements and the ITO and thus to reduce the extent of light loss and/or color shift affecting the light propagating through the light guide plate.

The adhesion layer is preferably between 50 nm and 100 nm thick, in order to make the layer sufficiently thick for maintaining a high reflectivity, thus avoiding light-absorption induced light losses in the light guide plate, while keeping it sufficiently thin to avoid spacer deformations (hillocks) caused by the exposure of the spacer elements to elevated processing temperatures.

The first protecting layer is preferably at least 100 nm thick in order to minimize the chance of spacer deformations (i.e. hillocks formations) when the spacer elements are subjected to elevated processing temperatures during the physical deposition of an insulating layer on the spacer elements and their associated ITO electrodes.

The conducting metal layer is preferably between 0.5 μm and 1.5 μm thick, the lower limit being set to maximize the spacer element conductivity, the upper limit being set equal to the maximum allowed spacer height.

According to some embodiments, the conducting metal layer is constituted by the first protecting layer.

The second protecting layer is preferably at least 50 nm thick, this minimum thickness being set to provide sufficient protection to the spacer elements against chemical attack by alkaline photoresist-stripping fluids during the wet-chemical processing/structuring of the spacer elements. According to some embodiments, the second protection layer is constituted by the conducting metal layer and possibly also the first protecting layer to form one single-material layer.

According to a preferred embodiment, an additional electrical insulating layer is deposited on top of the spacer elements on the light guide plate and on top of the row-directed spacer elements on the passive plate, so as to improve the electrical insulation of the foil electrode from said spacer elements on the active plate and from said row-directed spacer elements on the passive plate. Preferably, the additional electrical insulating layer is an inorganic layer measuring at least 100 nm in thickness. Thereby short circuits between the foil electrode and the spacer elements on the light guide plate and/or the row-directed spacer elements on the passive plate are effectively eliminated.

In another embodiment, the additional insulating layer is a continuous layer deposited on top of every spacer element on the light guide plate, on top of every row-directed spacer element on the passive plate, and on top of every transparent electrode on said light guide plate and said passive plate. In yet another embodiment, the additional insulating layer is deposited only on the top surface (facing the foil) of every spacer element on the light guide plate but is not deposited on the side surfaces of the spacer elements on the light guide plate that connect the top surfaces of the spacer elements with the top surfaces of the transparent electrodes on the light guide plate. The absence of the insulating layer at the side surfaces of the spacer elements on the light guide plate prevents unwanted light leakage from the interior of the light guide plate via the insulating layer towards the outside.

Combining the spacer elements on the light guide plate and the row-directed spacer elements on the passive plate with the transparent column and row electrodes, respectively, thus provides a number of advantages, including:

The aperture of each pixel can be increased, since the additional prior art resistance-reducing tracks are eliminated from the ITO electrodes.

The height of the resistance-reducing track formed by the spacer is less critical; it can now be made as high as the height of the prior art spacers.

The chemical reaction between the aluminum adhesion layer and the ITO of the column and row electrodes is now confined to very limited areas, namely the surface areas of the contact points needed in order to provide proper electrical contact between the spacer and the associated ITO layer. In total, the total light absorbing aluminum/ITO contact area on the light guide is now substantially reduced.

The adhesion problem between the resistance-reducing tracks and the ITO layers are eliminated, since the adhesion now occurs mainly on the glass of the light guide plate and on the glass of the passive plate.

The total number of process steps is reduced, since spacers and resistance-reducing tracks can be provided for simultaneously in one single process.

The combination of the column-directed spacer elements on the passive plate with the transparent foil electrode has the advantage of reducing the electrical resistance of the foil electrode without having to provide for resistance-reducing tracks directly on the foil itself.

In the following various embodiments of the invention will be further described with reference to the accompanying drawings, on which:

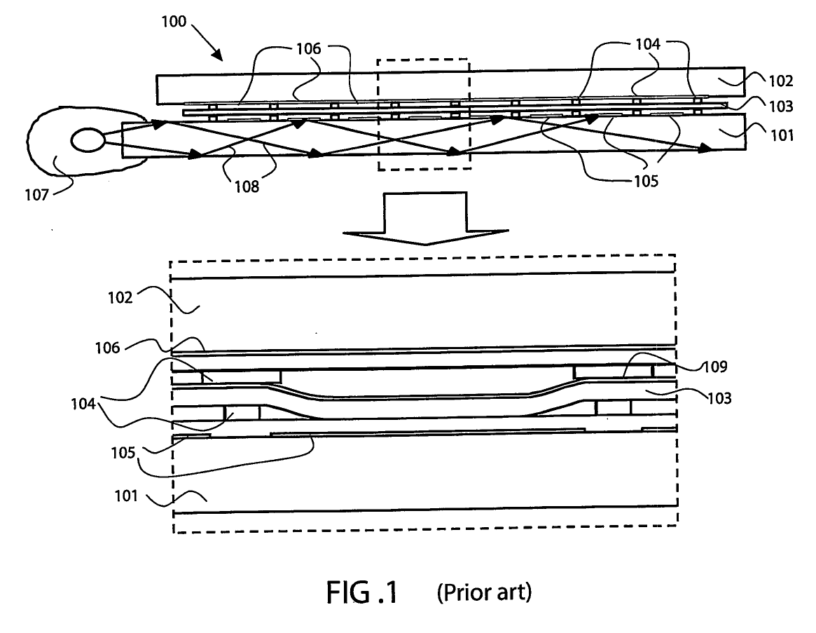

FIG. 1 shows a cross-section of a prior art dynamic foil display, and a magnification of a single pixel element.

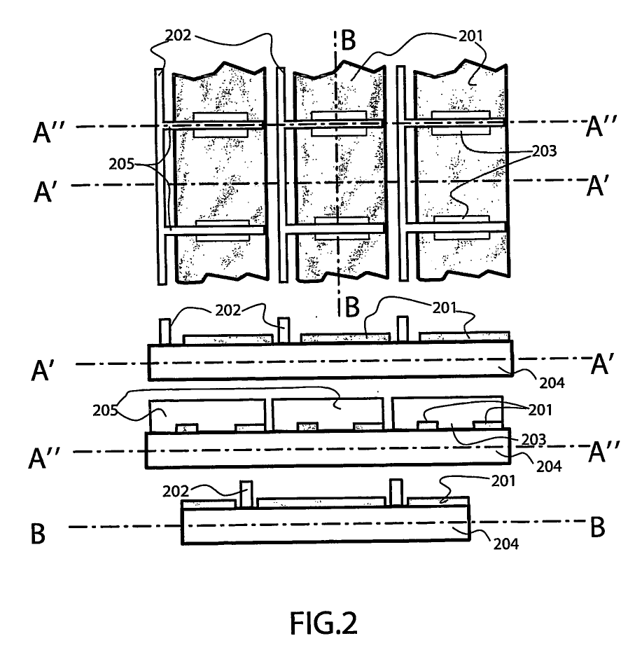

FIG. 2 shows a top view of an inventive column electrode circuitry.

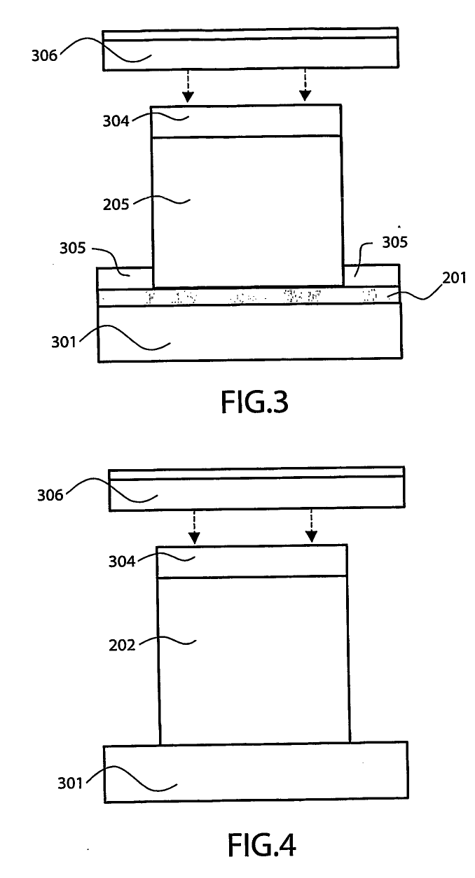

FIGS. 3 and 4 show cross sections of the column electrode circuitry of FIG. 2.

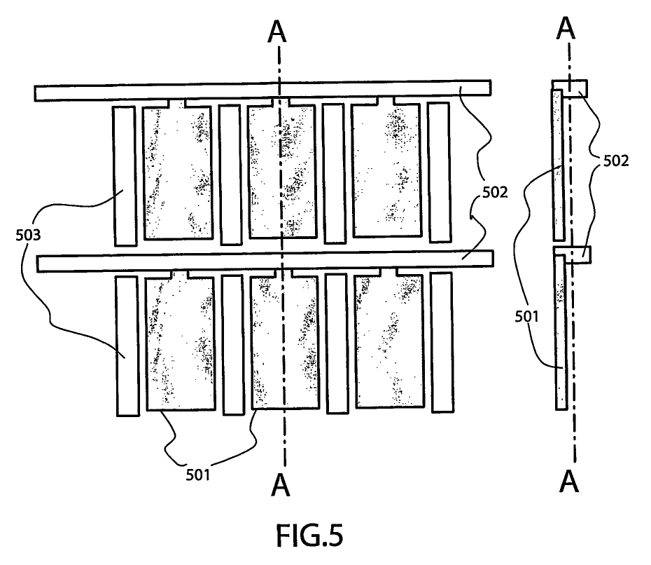

FIG. 5 shows a top view of an inventive row electrode circuitry.

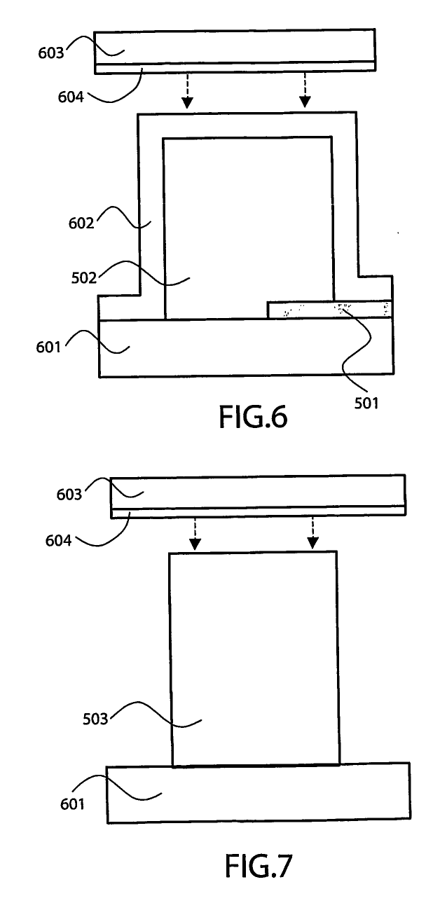

FIGS. 6 and 7 show cross sections of the row electrode circuitry of FIG. 5.

FIG. 8 shows embodiments of an inventive composite spacer element.

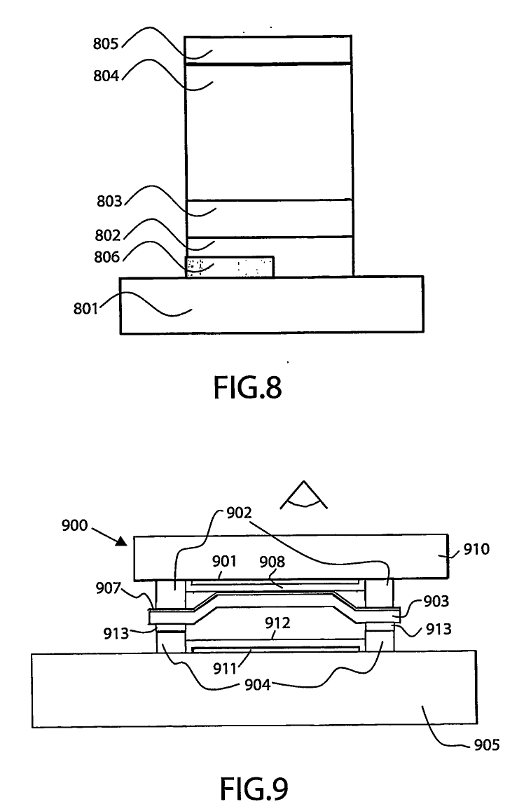

FIG. 9 shows a cross-section of an inventive display pixel element.

In FIG. 1 a cross section of a prior art foil display 100 is shown. The display comprises a light guide 101 and a passive plate 102. Between these substrates a light scattering foil 103 is arranged, which is separated from the substrates by means of spacers 104. A column electrode circuitry 105 formed out of ITO is arranged on the light guide 101, and a row electrode circuitry 106 is formed on the passive plate 102. A light source 107 connected to the light guide 101 is schematically shown, as well as light rays 108 traveling in the light guide 101. Also shown is a cross section of an enlarged portion of the display 100, illustrating a single activated pixel in further detail. The enlargement further shows a transparent foil electrode 109, deposited on the passive plate side of the foil 103. The enlarged pixel shown is in an activated state, the foil thus being in contact with the light guide and consequently decoupling light from the light guide.

In FIG. 2 a top view of an inventive column circuitry on the light guide plate is shown. The shaded areas 201 indicate layers of ITO and the stripes 202 indicate conductive spacer elements embodied as composite tracks comprising an aluminum adhesion layer. The spacer elements are directed parallel to the ITO electrode layers, but branches 205 off across a neighboring ITO layer with regular intervals, each interval delimiting a pixel. In order to reduce the contact area between the spacer elements 202, 205 and the ITO layers 201, and thus the Al/ITO interface area forming darkened light-absorbing regions, openings 203 are provided in the ITO layers. The spacer elements thus only contacting the ITO layers at the outer edge portions of the ITO electrode layers. As a result, the direct ohmic contact between the aluminum and the ITO is limited to only small surface areas and the effect of the chemical reaction between ITO and aluminum and thus the loss and/or discoloration of light in the light guide is kept to a minimum. Cross section A′-A′ illustrates ITO layers 201 and spacer elements 202, deposited on a glass light guide 204. Cross section A″-A″ illustrates conductive spacer element branches 205 partially covering the ITO layer, thus providing electrical contact, and partially being deposited in the openings 203. Cross section B-B illustrates, from the transversal direction, the spacer element track 202 being deposited in the openings 203.

In FIG. 3 a schematic cross section of the spacer branch 205 of FIG. 2 is shown. The spacer comprises an electrically conducting spacer element 205 arranged on the electrode 201 which in turn is arranged on a light guide plate 301. On the top surface of the spacer element 205 as well as on the electrode 201, electrically insulating layers 304, 305 are deposited in order to provide robust insulation from the foil 306 which is to be arranged on top of the spacer. In FIG. 4 a schematic cross section of the spacer element 202 of FIG. 2 is shown. The spacer element is arranged directly on the light guide plate 301 and is covered by an insulating layer 304. No insulation is needed on the light guide plate itself. However, for ease of manufacturing the insulating layer 305 arranged on the electrode 201 might also extend across regions of the light guide which is not covered by electrode material.

In FIG. 5 a top view of two inventive row electrodes for a passive plate are shown. The six ITO areas 501 each define a separate pixel. Cross section A-A shows the conductive row-directed spacer elements 502 that are locally in electrical contact with the transparent ITO layers 501 associated with the row electrodes. As can be seen, the ITO electrodes are structured so as to restrict the contact area between ITO and the spacers. Thus, also here the direct contact interface between the ITO and the aluminum of the row-directed spacer element is kept to a minimum in order to maintain a sufficiently strong adhesion between the row-directed spacer elements and the passive plate (but is of course chosen to be sufficiently large so that proper ohmic contact is established). The column-directed spacer elements 503 plate are located in between adjacent ITO electrode layers 501 and are electrically insulated from both the row-directed spacer elements 502 and the ITO electrode layers 501.

In FIG. 6 a schematic cross section of the spacer element 502 of FIG. 5 is shown. The spacer element is partially deposited on the row electrode 501 and partially deposited directly on the passive plate 601. Also shown are a foil 603 and a foil electrode 604, which are subsequently to be deposited on the spacer element. In order to provide for robust insulation of the row electrode from the foil electrode, an insulating layer 602 is encapsulating the spacer 502 as well as the electrode 501. Alternatively, the insulation on the side portions of the spacer can be omitted. In FIG. 7 is shown a schematic cross section of the column directed spacer 503 of FIG. 5. The spacer is arranged on the passive plate 601, and the foil 603 and foil electrode 604 are subsequently arranged directly on the spacer 503, in order to establish electrical contact between the spacer 503 and the foil electrode 604.

The spacer elements can be formed out of a homogenous, electrically conducting material such as aluminum. However, as stated above such spacer elements are related to a number of problems. Therefore, a composite resistance-reducing spacer element as shown in FIG. 8 is advantageous for many applications. The composite spacer is arranged on a glass substrate 801 and comprises an adhesion layer of aluminum 802, which is partly in adhesive contact with underlying ITO tracks 806 and partly in direct contact with the glass substrate 801. A first protecting layer 803 of chromium covers the aluminum adhesion layer 802. On top of the first protecting chromium layer 803 a substantially thicker conducting metal layer 804 is deposited, for example comprising aluminum or chromium, which in turn is covered by a second protecting alkaline-resistant chromium layer 805. Such a composite spacer element can be used on either or both of the light guide and passive plates. In order to reduce the light absorption from the light guide, it is highly advantageous to use composite spacer elements at least for the light guide spacers.

A spacer as shown in FIG. 8 can be manufactured as follows: First a thin ITO column electrode layer (30 nm or less) is structured on the light guide. Then spacer elements on the light guide plate are structured consisting of: A thin adhesion layer of aluminum (50-100 nm thick, also Ag, Mg or a combination of these elements can be used such as to provide a high reflectivity) partially in contact with the ITO column electrode layer, a thin protecting layer of Cr (100-200 nm thick, any high melting point metal will do) to suppress the formation of hillocks from the underlying aluminum adhesion layer that may arise when the spacer elements are exposed to a high processing temperature, a thick conducting aluminum layer (0.5-1.5 μm thick, or any other metal will do (e.g. Cu or Cr)) to form the spacer elements and to create the desired low resistivity of the spacer elements, and finally a thin alkaline-resistant Cr-layer (50-100 nm thick) to provide protection of the spacer element against chemical attack by alkaline resist-stripping fluids during the wet-chemical processing/structuring of the spacer elements.

It is not possible to deposit 1 μm thick aluminum spacer elements directly on ITO due to adherence problems and the traditional adherence layers (like Cr and Ti) cannot be used due to their high light absorption, which would lead to a substantial loss of light intensity inside the light guide.

Spacer elements on the passive plate can be manufactured in the same way as the spacer elements on the light guide plate but the row-directed spacers are brought into contact with the ITO of the row-electrode layers while the column-directed spacer elements on the passive plate are deposited directly on the glass of the passive plate and are thereby kept electrically insulated from both the ITO row electrode layers and the row-directed spacer elements on the passive plate.

A dielectric insulating layer is preferably deposited on the row-directed spacer elements and on the ITO layers associated with the row electrodes on the passive plate, in order to electrically insulate the row electrodes from the foil electrode. Preferably also the ITO layers associated with the column electrodes and the top surfaces of the spacer elements on the light guide plate are covered with a dielectric insulating layer, in order to electrically insulate the column electrodes from the foil electrode. The dielectric insulating layer preferably consists of an inorganic oxide or an inorganic nitride material e.g. Al₂O₃, Si₃N₄, TiO₂ or SiO₂.

A side view of a single foil display pixel 900 in the OFF-state is shown in FIG. 9. The pixel is arranged on a light guide 905 on which column spacers 904 and a column electrode 911 are arranged. Insulating layers 912 and 913 (e.g. SiO₂) are arranged on the column electrode 912 and the column spacers 904, respectively, and separate the column circuitry from the foil 903 and foil electrode 907. Alternatively, the insulating layer can be omitted and the foil itself thus being the insulating medium between the column electrode and the foil electrode. In order to prevent light leakages from the light guide, the insulating layer is restricted to the lateral surfaces of the column circuitry, i.e. the top surfaces of the spacer elements and the top surfaces of the ITO layers, leaving the side surfaces of the spacer elements open. Otherwise a certain amount of light will be decoupled from the light guide via the insulating layer even if the pixel is in its OFF-state. Passive plate column spacers 902 and a row electrode 901 are arranged on the passive plate 910, separated from each other. An insulating layer 908 covers the row electrode 901 whereas the passive plate column spacers 902 are in direct electrical contact with the foil electrode 907.

The present invention thus reduces the number of processing steps, increases the pixel aperture because no space is occupied by separate resistance reducing tracks, and minimizes the row and column electrode RC time because the resistance reduction by the spacers is much larger than what can be accomplished with the previously discussed separate resistance-reducing tracks on ITO.

It is to be understood that the skilled man readily envisages many variations of the present invention. For example, the row and column configuration can of course be inverted, the row circuitry thus being arranged on the light guide and the column circuitry being arranged on the passive plate. It is of course also possible to invert the foil and foil electrode, the foil electrode thus being deposited on the light guide side of the foil, alternatively, the foil can also be homogeneously made out of a conducting material or insulated on both sides from the row and column circuitry by a separate insulating layer.

In summary, a dynamic foil display 900 is provided wherein the spacer elements 902, 904 also serve as resistance-reducing tracks for the electrode circuitry. Resistance-reduction can thereby be provided for the row and column electrodes as well as for the foil electrode without arranging separate resistance-reducing tracks. Thereby the addressing performance of the display is substantially improved and the manufacturing of the display simplified. To this end a foil display 900 comprises a light guide plate 905; a passive plate 910; and a transparent light-scattering foil 903 sandwiched between and separated from said plates by means of spacer elements 902, 904 is described. The spacer elements 902, 904 are arranged essentially along rows and columns on said plates 905, 910 and thereby define a plurality of pixel elements arranged in a matrix configuration along said rows and columns. The display further comprises an electrode circuitry which comprises a transparent foil electrode 907 arranged laterally on said foil and transparent row and column electrodes 901, 911 arranged along said rows and columns on said light guide and passive plates; and the spacer elements 902, 904 are electrically conducting and interconnected with said electrodes 907, 911, 901 and thus form part of said electrode circuitry.

1. A foil display (900) comprising
a light guide plate (905);
a passive plate (910);
a transparent light-scattering foil (903) sandwiched between and separated from said plates by means of spacer elements (920, 904), said spacer elements being arranged essentially along rows and columns on said plates and thereby defining a plurality of pixel elements arranged in a matrix configuration along said rows and columns;
an electrode circuitry comprising a transparent foil electrode (907) arranged laterally on said foil and transparent row and column electrodes (901, 911) arranged along said rows and columns on said light guide and passive plates;
characterized in that said spacer elements are electrically conducting and interconnected with said electrodes and thus form part of said electrode circuitry.

2. A foil display according to claim 1, wherein some of the spacer elements (502) are essentially parallel with said row electrodes (501) and electrically interconnected therewith.

3. A foil display according to claim 1, wherein some of the spacer elements (202) are essentially parallel with said column electrodes (201) and electrically interconnected therewith.

4. A foil display according to claim 1, wherein some of the spacer elements (503) on at least one of said plates are electrically interconnected with said foil electrode and are spatially separated from and extend in a direction essentially transversal to the remaining spacer elements on said at least one plate.

5. A foil display according to claim 1, wherein said transparent row and column electrodes are formed out of ITO (901, 911).

6. A foil display according to claim 1, wherein said spacer elements (902, 904) comprise aluminum.

7. A foil display according to claim 2 or 3, wherein said spacer elements (202, 502) electrically interconnected with said row or column electrodes (201, 501) are deposited partially on the respective transparent electrodes and partially on the respective plate.

8. A foil display according to claim 1, wherein the spacer elements comprise:
a reflective adhesion layer (802) of Al or Ag, arranged at least partially on a transparent electrode layer (806);
a first protecting layer (803) of a high-melting point metal, deposited on said adhesion layer;
a conducting metal layer (804), deposited on said first protecting layer; and
a second protecting layer (805) of an alkaline-resistant metal, deposited on said conducting metal layer.

9. A foil display according to claim 8, wherein said adhesion layer (802) is between 50 nm and 100 nm thick.

10. A foil display according to claim 8, wherein said first protecting layer (803) is at least 100 nm thick.

11. A foil display according to claim 8, wherein said first protecting layer (803) is formed out of Cr.

12. A foil display according to claim 8, wherein said conducting metal layer (804) is between 0.5 μm and 1.5 μm thick.

13. A foil display according to claim 8, wherein said conducting metal layer (804) is formed out of Al.

14. A foil display according to claim 8, wherein said second protecting layer (805) is at least 50 nm thick.

15. A foil display according to claim 8, wherein said second protecting layer (805) is formed out of Cr.

16. A foil display according to claim 1, wherein an insulating layer is deposited on said foil electrode, so as to insulate said foil electrode from said spacer elements and said transparent electrodes.

17. A foil display according to claim 1, wherein insulating layers (304; 602) are deposited on top of at least parts of said spacer elements.

18. A foil display according to claim 17, wherein a continuous insulating layer (602) is deposited on top of every spacer element and every transparent electrode on said passive plate.
